(19) United States
(12) Patent Application Publication
(10) Pub. No.: US 2019/0102754 A1
(43) Pub. Date: Apr. 4, 2019

(54) POINT-OF-SALE DEVICE INCLUDING AN ELECTRONIC RECEIPT AGENT

(71) Applicant: TOSHIBA TEC KABUSHIKI KAISHA, Tokyo (JP)

(72) Inventor: Takahide KUBOTA, Mishima Shizuoka (JP)

(21) Appl. No.: 16/151,550

(22) Filed: Oct. 4, 2018

(30) Foreign Application Priority Data
Oct. 4, 2017 (JP) 2017-194609

(51) Int. Cl. G06Q 20/04; G06K 15/02; G06Q 20/20

(52) U.S. Cl. CPC G06Q 20/0453; G06Q 20/209; G06K 15/181

(57) ABSTRACT

A point-of-sale device executes an electronic receipt agent to implement an electronic receipt system. The agent includes an input processing unit that receives, via an input device, data related to a commercial transaction, and outputs the data to the POS device that generates receipt data on the basis of the data. A print processing unit controls a print device to print a receipt based on the generated receipt data. A transmission processing unit transmits the receipt data to a server that stores the receipt data. A determination unit determines whether the data requires an electronic receipt. A switching unit provides the receipt data to the transmission processing unit if the data requires the electronic receipt. The switching unit also provides the receipt data to the print processing unit if the data does not require the electronic receipt.

### CROSS-REFERENCE TO RELATED APPLICATION

This application is based upon and claims the benefit of priority from Japanese Patent Application No. 2017-194609, filed in Oct. 4, 2017, the entire contents of which are incorporated herein by reference.

### FIELD

Embodiments described herein relate generally to a point-of-sale (POS) device including an electronic receipt agent.

### BACKGROUND

In recent years, an electronic receipt system has been introduced to some stores. The electronic receipt system generates electronic receipts issued to shoppers from POS (Point Of Sales) terminals in the stores and stores the electronic receipts in a center server. Then, the electronic receipt system allows the shoppers to be able to download the electronic receipts stored in the center server to information terminals such as smart phones.

When such an electronic receipt system is introduced, since paper receipts are not issued in the stores, it is possible to omit receipt printing time. Furthermore, since it is possible to save receipt paper, there is a benefit of reduced cost.

Accordingly, stores that newly introduce the electronic receipt system are increasing. However, in order to introduce the electronic receipt system, it is necessary to update dedicated application software installed in the POS terminal, so called a POS application. This issue prevents the widespread adoption of the electronic receipt system. Such a problem can be solved by developing software for data processing related to the electronic receipt system, instead of the POS application.

### DESCRIPTION OF THE DRAWINGS

FIG. 1 illustrates a schematic diagram of an electronic receipt system;

FIG. 2 illustrates a block diagram of a hardware configuration of a POS terminal;

FIG. 3 illustrates a block diagram illustrating main software of the POS terminal;

FIG. 4 illustrates a detailed block diagram illustrating main elements of FIG. 3;

FIG. 5 illustrates a flowchart illustrating a main operation of a processor of the POS terminal including an electronic receipt agent; and

FIG. 6 illustrates another flowchart illustrating a main operation of the processor of the POS terminal including the electronic receipt agent.

### DETAILED DESCRIPTION

Embodiments provide a point-of-sale (POS) device including an electronic receipt agent for data processing related to an electronic receipt system, instead of a POS application, and a method thereof.

A POS device executes an electronic receipt agent to implement an electronic receipt system. The agent includes an input processing unit that receives, via an input device, data related to a commercial transaction, and outputs the data related to the commercial transaction to an execution unit of an application program of the POS device that generates receipt data on the basis of the data. A print processing unit controls a print device to print a receipt based on the receipt data generated by the application program of the POS device. A transmission processing unit controls a communication device to transmit the receipt data to a server that stores the receipt data. A determination unit determines whether the data input via the input device requires an electronic receipt. A switching unit provides the receipt data generated by the execution unit to the transmission processing unit if the determination unit determines that the data input via the input device requires the electronic receipt. The switching unit also provides the receipt data generated by the execution unit to the print processing unit if the determination unit determines that the data input via the input device does not require the electronic receipt.

Hereinafter, an embodiment of an electronic receipt agent capable of undertaking data processing related to an electronic receipt system, instead of a POS application, will be described with reference to the drawings. Firstly, the electronic receipt system will be described.

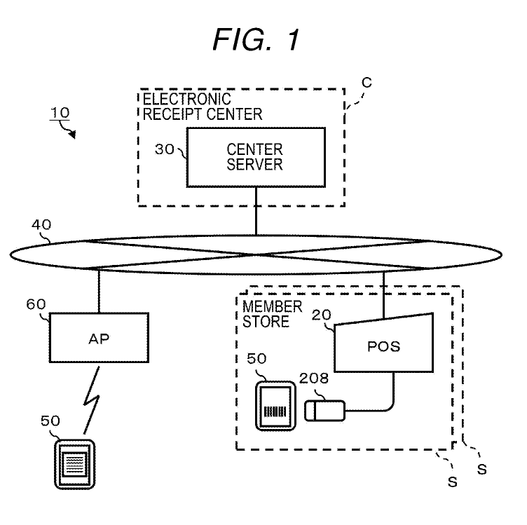

FIG. 1 is a schematic diagram illustrating an electronic receipt system 10. The electronic receipt system 10 includes a POS terminal 20 provided in each member store S, a center server 30 provided in an electronic receipt center C, and a network 40. The member store S is a store that is registered to use the electronic receipt system 10. The electronic receipt center C is a computer center managed by an operating entity that manages the electronic receipt system 10. The network 40, for example, is the Internet. The POS terminal 20 in each member store S and the center server 30 in the electronic receipt center C are connected to the network 40 via communication devices such as routers, respectively.

A consumer (a shopper) needs an information terminal 50 in order to use the electronic receipt system 10. The information terminal 50 is a portable electronic device capable of performing wireless communication by using a wireless LAN (Local Area Network) or mobile communication technology. A plurality of access points 60 corresponding to wireless LAN or mobile communication are connected to the network 40. The information terminal 50 can wirelessly communicate with the center server 30 via any one of the access points 60. As the information terminal 50, for example, a smart phone, a tablet terminal, a mobile phone and the like may be used.

A consumer using the electronic receipt system installs a dedicated application program in the information terminal 50 and performs electronic receipt member registration. When the member registration is performed, a member ID unique to the consumer is issued. After the member ID is issued, the application program is executed, causing a barcode indicating the member ID to be displayed on a display device of the information terminal 50. Accordingly, when the consumer performs shopping in the member store S and performs accounting of purchased commodities with a salesperson in charge of accounting, the consumer presents the barcode of the member ID displayed on the display device. The salesperson reads the barcode of the member ID by using a barcode reading scanner 208 provided to the POS terminal 20.

When the barcode of the member ID is read by the scanner 208, the POS terminal 20 recognizes it as a commercial transaction in which a receipt is issued as an electronic receipt instead of a paper receipt. Then, the POS terminal 20 generates and transmits electronic receipt data indicating details of the commercial transaction, to the center server 30 together with the member ID acquired from the barcode.

The center server 30 stores the electronic receipt data, which is received from each POS terminal 20, in association with the member ID. Thereafter, when a request command for the electronic receipt data including the member ID is received from the information terminal 50, the center server 30 wirelessly transmits the electronic receipt data associated with the member ID to the information terminal 50 which is a request source. In the information terminal 50 receiving the electronic receipt data, a receipt image is displayed on the display device on the basis of the electronic receipt data. Thus, the consumer can confirm receipts not received at the time of accounting in the member store S.

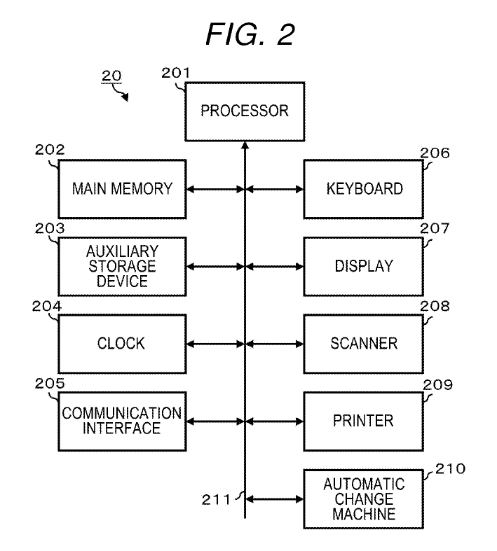

The electronic receipt agent of the present embodiment is applied to the POS terminal 20. Next, the POS terminal 20 will be described. Firstly, a hardware configuration of the POS terminal 20 will be described with reference to FIG. 2.

FIG. 2 is a block diagram illustrating a hardware configuration of the POS terminal 20. The POS terminal 20 includes a processor 201, a main memory 202, an auxiliary storage device 203, a clock 204, a communication interface 205, a keyboard 206, a display 207, a scanner 208, a printer 209, an automatic change machine 210, and a system bus 211. In the POS terminal 20, the processor 201, the main memory 202, the auxiliary storage device 203, the clock 204, the communication interface 205, the keyboard 206, the display 207, the scanner 208, the printer 209, and the automatic change machine 210 are connected via the system bus 211 in a direct manner or via a signal input and output circuit. Thus, the POS terminal 20 functions as a computer by the processor 201, the main memory 202, the auxiliary storage device 203 connected to each other via the system bus 211.

The processor 201 corresponds to a central controller of the aforementioned computer. The processor 201 controls each component that performs various functions of the POS terminal 20, according to an operating system and an application program.

The main memory 202 corresponds to a main storage of the aforementioned computer. The main memory 202 includes a nonvolatile memory area and a volatile memory area. The main memory 202 stores the operating system and the application program in the nonvolatile memory area. Furthermore, there are cases where the main memory 202 stores data, which is required when the processor 201 performs processes for controlling each element, in the nonvolatile or volatile memory area. The main memory 202 uses the volatile memory area as a work area where data is appropriately rewritten by the processor 201.

The auxiliary storage device 203 corresponds to an auxiliary storage of the aforementioned computer. For example, an EEPROM (Electric Erasable Programmable Read-Only Memory), an HDD (Hard Disc Drive), an SSD (Solid State Drive) and the like are used as the auxiliary storage device 203. The auxiliary storage device 203 stores data to be used when the processor 201 performs various processes, and data generated by the processes in the processor 201. There are cases where the auxiliary storage device 203 stores the aforementioned application program.

The clock 204 functions as a time information source of the POS terminal 20. The processor 201 receives current date and time on the basis of time information counted by the clock 204.

The communication interface 205 performs data communication with a store server and the like in the store S via a LAN (Local Area Network). Furthermore, the communication interface 205 is connected to the network 40 via a router connected to the LAN, and performs data communication with the center server 30 via the network 40 according to the predetermined protocol.

The keyboard 206 is provided with various keys, such as a numeric keypad, a subtotal key, and a settlement key, which are required for the POS terminal 20, and receives input of various instructions by an operator. The keyboard 206 functions as an input device of the POS terminal 20. Instead of the keyboard 206, a touch panel in combination with the keyboard 206 can also be applied as this type of input device. The operator is typically a salesperson in charge of accounting. However, a shopper, which is a consumer, may also be the operator.

The display 207 displays various screens for notifying the operator of various types of information. The display 207 functions as a display device of the POS terminal 20. The display 207 is not limited to one. For example, the POS terminal 20 may also include two displays 207 for a salesperson and a shopper.

The scanner 208 optically scans and reads a barcode. The scanner 208 functions as an input device of the POS terminal 20. Each commodity has a barcode indicating a commodity code unique to the commodity. The scanner 208 can read the barcode provided on each commodity. Furthermore, as described above, when the barcode of the member ID, which indicates the member ID, is displayed on the display device of the information terminal 50, the scanner 208 can read the barcode. In addition, the scanner 208 may also read code symbols other than the barcode, for example, two-dimensional data codes.

The printer 209 prints a receipt image on a receipt paper and issues a paper receipt. The printer 209 may also print data on a paper other than the receipt paper, for example, a journal paper. The printer 209 functions as a print device of the POS terminal 20.

The automatic change machine 210 has paper money and coin slots and calculates the amount of an inserted paper money or coins. Then, the automatic change machine dispenses a difference obtained by subtracting a transaction amount from the amount of the inserted paper money or coins through a dispensing port in the form of paper moneys or coins corresponding to a change amount. Instead of the automatic change machine 210, a drawer for receiving cash may also be provided.

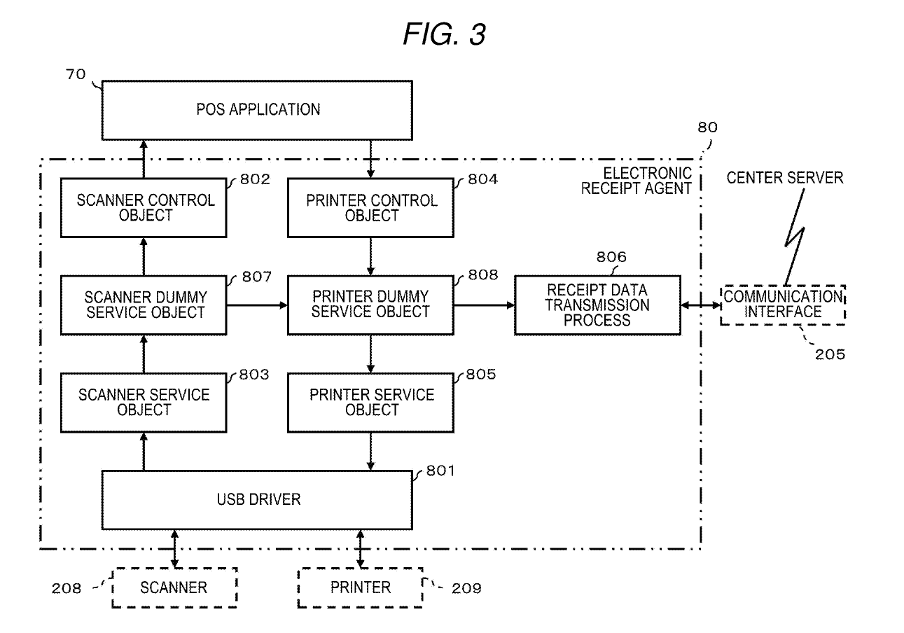

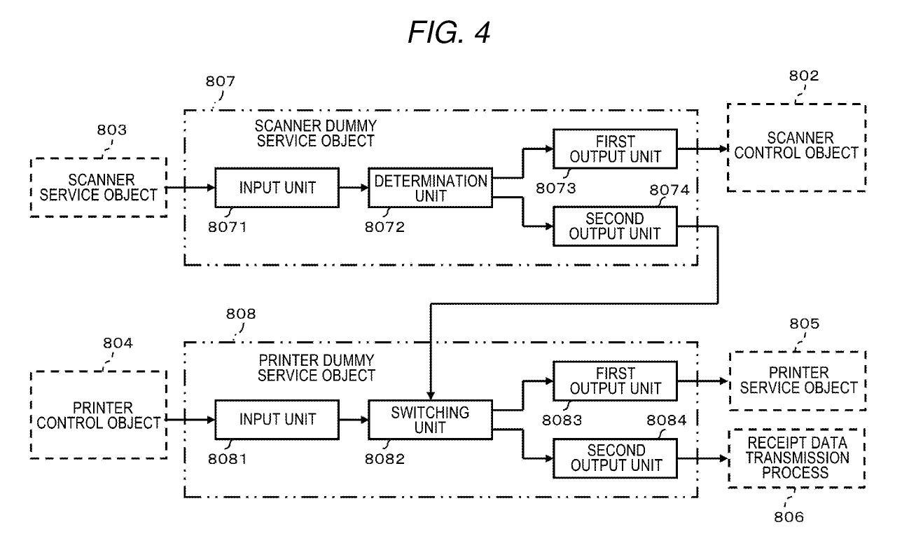

Next, a software configuration of the POS terminal 20 will be described with reference to FIG. 3 and FIG. 4.

FIG. 3 is a block diagram illustrating main software of the POS terminal 20, and FIG. 4 is a detailed block diagram illustrating details of certain elements (a scanner dummy service object 807 and a printer dummy service object 808) of FIG. 3. As illustrated in FIG. 3, the POS terminal 20 includes a POS application 70 and an electronic receipt agent 80.

The POS application 70 is a program for controlling devices of the keyboard 206, the display 207, the scanner 208, the printer 209 and the like and allowing the computer, in which the processor 201 is a main controller, to perform information processing related to commodity sales. That is, the computer, in which the processor 201 is a main controller, functions as an execution unit of the POS application 70.

The information processing related to commodity sales includes a registration process and a settlement process. The registration process is a process in which commodity codes of commodities purchased by a shopper are input via the input devices (the keyboard 206, the scanner 208 and the like). When the commodity codes are input, sales data of the commodities specified by the commodity codes is generated and registered in a transaction memory. Furthermore, the registration process includes a process in which commodity names, cost and the like of the sales data registered in the transaction memory are displayed on the display devices (the display 207 and the like). The transaction memory is allocated in the volatile memory area of the main memory 202.

The settlement process is a process in which, when registration completion of a commercial transaction is requested by the input of the settlement key, a transaction amount is calculated on the basis of the data registered in the transaction memory, and then, when payment data is input, a transaction amount is paid for according to the payment data. Furthermore, the settlement process includes a process in which receipt data is generated on the basis of the data registered in the transaction memory. The payment data includes data of a deposit amount in the case of cash settlement, a balance of an electronic money card in the case of electronic money settlement, or remaining points of a point card in the case of point settlement.

The electronic receipt agent 80 performs data processing related to the electronic receipt system on behalf of the POS application 70. That is, the electronic receipt agent 80 controls the input device used for reading the member ID, that is, the scanner 208. Furthermore, the electronic receipt agent 80 controls the print device used for printing a receipt, that is, the printer 209. Moreover, the electronic receipt agent 80 controls the communication interface 205 which is the communication device used for transmitting receipt data.

Specifically, the electronic receipt agent 80 includes a USB (Universal Serial Bus) driver 801, a scanner control object 802, a scanner service object 803, a printer control object 804, a printer service object 805, a receipt data transmission process 806, the scanner dummy service object 807, and the printer dummy service object 808. The USB driver 801 belongs to a kernel space. The scanner control object 802, the scanner service object 803, the printer control object 804, the printer service object 805, the receipt data transmission process 806, the scanner dummy service object 807, and the printer dummy service object 808 belong to a user space.

The USB driver 801 is software that controls data communication with devices that have a USB interface. In the present embodiment, the scanner 208 and the printer 209 are devices that have the USB interface and are connected to a body of the POS terminal 20 through a USB cable.

The scanner control object 802 and the scanner service object 803 are software which have interfaces conforming to open POS standard specifications with respect to the POS application 70 and are provided in correspondence to the scanner 208.

The scanner control object 802 provides the POS application 70 with a data set of a property, a method, and an event related to the scanner 208. The POS application 70 transmits an execution request to the scanner 208 through the method and the property provided from the scanner control object 802. Then, the POS application 70 acquires processing results of the scanner 208 from the scanner control object 802 through a return value of the method, the property, and the event.

The scanner service object 803 corresponds to a manufacturer and a model of the scanner 208, and is called by the scanner control object 802. That is, the scanner service object 803 controls the scanner 208 to perform the request from the POS application 70, receives the processing results from the scanner 208, and outputs the processing results to the scanner control object 802.

The scanner control object 802 and the scanner service object 803 function as an input processing unit that outputs data related to a commercial transaction, which is input via the input device (the scanner 208), to an execution unit of an application program that generates receipt data on the basis of the data.

The printer control object 804 and the printer service object 805 are software which have interfaces conforming to the open POS standard specifications with respect to the POS application 70 and are provided in correspondence to the printer 209.

The printer control object 804 provides the POS application 70 with a data set of a property, a method, and an event related to the printer 209. The POS application 70 transmits an execution request to the printer 209 through the method and the property provided from the printer control object 804. Then, the POS application 70 acquires processing results of the printer 209 from the printer control object 804 through a return value of the method, the property, and the event.

The printer service object 805 corresponds to a manufacturer and a model of the printer 209, and is called by the printer control object 804. That is, the printer service object 805 controls the printer 209 to perform the request from the POS application 70, receives the processing results from the printer 209, and outputs the processing results to the printer control object 804.

The printer control object 804 and the printer service object 805 function as a print processing unit that allows the print device (the printer 209) to print receipts on the basis of the receipt data.

The receipt data transmission process 806 is software that controls the communication interface 205 such that the receipt data generated in the data processing of the POS application 70 is transmitted to the center server 30. That is, the receipt data transmission process 806 converts the receipt data into structured data of an XML (Extensible Markup Language) format, a JCON (JavaScript Object Notation) format, or a CSV (Comma Separated Value) format. When the receipt data is structured, it is possible to distinguish elements (text data constituting the receipt) included in the receipt data from one another and specify the elements, so that it is possible to recognize an arrangement relation and the like among the elements, from only the data. Then, the receipt data transmission process 806 controls the communication interface 205 to transmit the receipt data converted into the structured data to the center server 30.

The receipt data transmission process 806 functions as a transmission processing unit that controls the communication device (the communication interface 205) to transmit the receipt data to the center server 30.

The scanner dummy service object 807 is software that is called by the scanner control object 802 and operates, similarly to the scanner service object 803. The scanner dummy service object 807 performs the following process with respect to the processing results of the scanner 208, which are output from the scanner service object 803 to the scanner control object 802.

The printer dummy service object 808 is software that is called by the printer control object 804 and operates, similarly to the printer service object 805. The printer dummy service object 808 performs the following process with respect to the receipt data output from the printer control object 804 to the printer service object 805.

FIG. 4 is a detailed block diagram illustrating processing configurations of the scanner dummy service object 807 and the printer dummy service object 808. Hereinafter, with reference to FIG. 4, the processing of the scanner dummy service object 807 and the printer dummy service object 808 will be described.

The scanner dummy service object 807 includes an input unit 8071, a determination unit 8072, a first output unit 8073, and a second output unit 8074. The input unit 8071 receives the output of the scanner service object 803, that is, the data of the barcode read by the scanner 208. Then, the input unit 8071 provides the input barcode data to the determination unit 8072.

The determination unit 8072 determines whether the barcode data input via the input unit 8071 is data requiring an electronic receipt. As described above, in the present embodiment, the consumer, who receives the receipt as the electronic receipt, presents the barcode of the member ID displayed on the display device of the information terminal 50 to the salesperson. The salesperson operates the scanner 208 and reads the barcode. Then, the determination unit 8072 determines whether the barcode data input via the input unit 8071 corresponds to the barcode of the member ID.

The barcode read by the scanner 208 typically is one of a barcode of a member ID and a barcode of a commodity code. The barcode of the member ID and the barcode of the commodity code are different from each other in terms of a code system. On the basis of the difference of the code system, the determination unit 8072 determines whether the barcode data is the data obtained by reading the barcode of the member ID.

When the barcode data is not the data obtained by reading the barcode of the member ID, the determination unit 8072 determines that the barcode data is not the data requiring the electronic receipt. In this case, the determination unit 8072 outputs the barcode data to the first output unit 8073. However, when the barcode data is the data obtained by reading the barcode of the member ID, the determination unit 8072 determines that the barcode data is the data requiring the electronic receipt. In this case, the determination unit 8072 outputs the barcode data to the second output unit 8074.

The first output unit 8073 outputs the barcode data input via the determination unit 8072 to the scanner control object 802.

The second output unit 8074 outputs the barcode data input via the determination unit 8072 to a switching unit 8082 of the printer dummy service object 808, which will be described later.

The scanner dummy service object 807 functions as a determination unit that determines whether data input via the input device (the scanner 208) is data (barcode data of a member ID) requiring an electronic receipt.

The printer dummy service object 808 includes an input unit 8081, the switching unit 8082, a first output unit 8083, and a second output unit 8084. The input unit 8081 receives the output of the printer control object 804, that is, the receipt data. Then, the input unit 8081 provides the input receipt data to the switching unit 8082.

The switching unit 8082 switches an output destination of the receipt data input via the input unit 8081 between the first output unit 8083 and the second output unit 8084. When the receipt data is input in a state in which the barcode data was not input from the second output unit 8074 of the scanner dummy service object 807, the switching unit 8082 sets the output destination of the receipt data as the first output unit 8083. That is, the switching unit 8082 outputs the receipt data to the first output unit 8083. However, when the receipt data is input in a state in which the barcode data was input from the second output unit 8074 of the scanner dummy service object 807, the switching unit 8082 sets the output destination of the receipt data as the second output unit 8084. That is, the switching unit 8082 outputs the receipt data to the second output unit 8084 together with the barcode data.

The first output unit 8083 outputs the receipt data input via the switching unit 8082 to the printer service object 805.

The second output unit 8084 outputs the receipt data input via the switching unit 8082 and the barcode data to the receipt data transmission process 806.

As described above, the printer dummy service object 808 provides the transmission processing unit (the receipt data transmission process 806) with the receipt data that was generated by the execution unit after the determination unit (the scanner dummy service object 807) determines that the barcode data is the data requiring the electronic receipt. Furthermore, the printer dummy service object 808 provides the print processing unit (the printer service object 805) with the receipt data that was generated by the execution unit when the determination unit (the scanner dummy service object 807) determines that the barcode data is not the data requiring the electronic receipt. The printer dummy service object 808 functions as a switching unit.

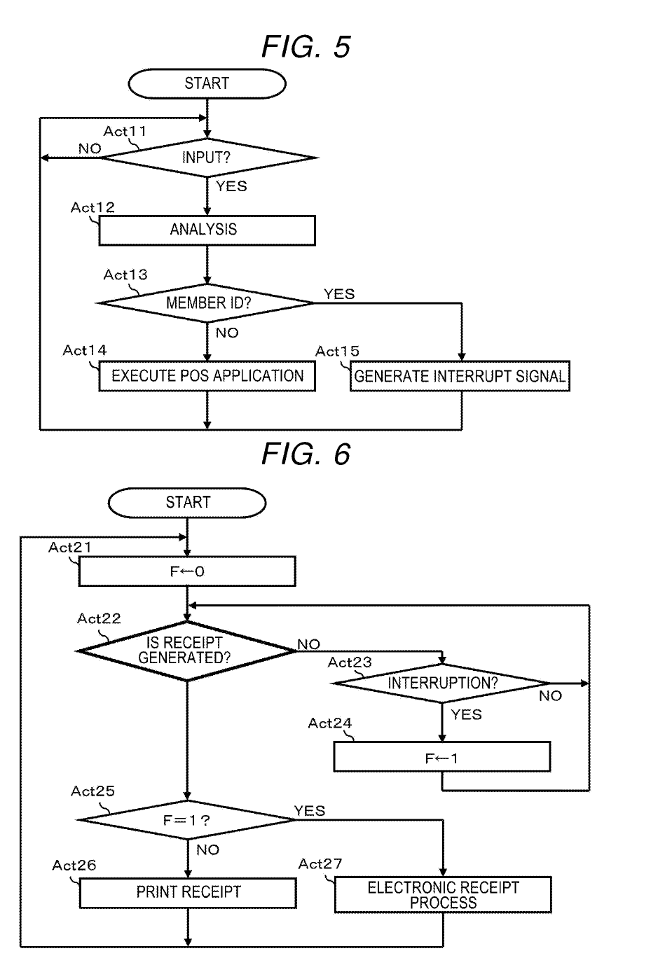

FIG. 5 and FIG. 6 are flowcharts illustrating a main operation of the processor 201 of the POS terminal 20 provided with the electronic receipt agent 80 described with reference to FIG. 3 and FIG. 4. Specifically, FIG. 5 illustrates an operation for processing the barcode data input from the scanner 208, and FIG. 6 illustrates an operation for processing the receipt data generated in the POS application 70. Firstly, the operation of the processor 201 for the barcode data will be described with reference to FIG. 5.

The processor 201 waits for the input of the barcode data from the scanner 208 (Act 11). When the barcode data is input from the scanner 208 (Act 11, YES), the processor 201 analyzes the barcode data (Act 12). Then, the processor 201 determines whether the barcode data is barcode data having a code system of a member ID (Act 13). When the processor 201 determines that the barcode data is not the barcode data having the code system of the member ID (Act 13, NO), the processor 201 executes the POS application 70 with the barcode data (Act 14).

However, when the processor 201 determines that the barcode data is the barcode data having the code system of the member ID (Act 13, YES), the processor 201 generates an interrupt signal including the barcode data (Act 15). Then, the processor 201 returns to Act 11 and waits for the input of subsequent barcode data.

Next, the operation of the processor 201 for the receipt data will be described with reference to FIG. 6.

The processor 201 resets a state flag F to “0” (Act 21). The state flag F is stored in the volatile memory area of the main memory 202. The processor 201 determines whether receipt data is generated by the process of the POS application 70 (Act 22). When the receipt data is not generated (Act 22, NO), the processor 201 determines whether an interrupt signal is generated (Act 23). When the interrupt signal is not generated (Act 23, NO), the processor 201 returns to Act 22. The processor 201 waits for generation of the receipt data or the interrupt signal by the processes of Act 22 and Act 23.

In the waiting states of Act 22 and Act 23, when the processor 201 confirms that the interrupt signal was generated (Act 23, YES), the processor 201 sets the state flag F to “1” (Act 24). Then, the processor 201 returns to the waiting states of Act 22 and Act 23.

In the waiting states of Act 22 and Act 23, when the processor 201 confirms that the receipt data is generated (Act 22, YES), the processor 201 determines the state flag F (Act 25). When the state flag F is the state reset to “0” (Act 25, NO), the processor 201 outputs the receipt data to the printer 209 and controls receipt printing (Act 26). However, when he state flag F is set to “1” (Act 26, YES), the processor 201 generates electronic receipt data based on the receipt data (Act 27) and controls the communication interface 205 such that the electronic receipt data is transmitted to the center server 30.

Thus, the processor 201 controls the receipt printing or controls the communication interface 205, and then returns to the process of Act 21. That is, the processor 201 resets the state flag F to “0” and waits for generation of receipt data or an interrupt signal.

As described above, in the electronic receipt agent 80, the scanner dummy service object 807 including the determination unit 8072 is interposed between the scanner control object 802 and the scanner service object 803. Furthermore, the printer dummy service object 808 including the switching unit 8082 is interposed between the printer control object 804 and the printer service object 805.

By so doing, barcode data read by the scanner 208 and received from the scanner service object 803 is provided to the scanner dummy service object 807. Then, by the scanner dummy service object 807, the barcode data of a member ID is output to the printer dummy service object 808. The barcode data of the member ID is not output to the POS application 70. On the other hand, barcode data, other than the barcode of the member ID, is provided to the execution unit of the POS application 70 by the scanner control object 802, and is used for the registration process and the settlement process.

Then, when receipt data is generated by the settlement process, the receipt data is provided from the printer control object 804 to the printer dummy service object 808. In this case, when the barcode data of the member ID is not provided to the printer dummy service object 808, the receipt data is output from the printer service object 805 to the printer 209. That is, a paper receipt is issued.

On the other hand, in a state in which the barcode data of the member ID was provided to the printer dummy service object 808, when the receipt data is generated, the receipt data is converted into structured data (i.e., electronic receipt data) by the receipt data transmission process 806. The electronic receipt data is transmitted to the center server 30 via the communication interface 205 together with the barcode data.

As described above, according to the electronic receipt agent 80, it is possible to undertake data processing related to the electronic receipt system, on behalf of the POS application 70. Consequently, it is possible to utilize the POS terminal 20 in the electronic receipt system 10 without repairing an existing POS application 70.

Furthermore, the electronic receipt agent 80 includes the scanner control object 802 and the scanner service object 803 as software corresponding to the scanner 208, and has a configuration in which the scanner dummy service object 807 is further interposed between the scanner control object 802 and the scanner service object 803. Consequently, the electronic receipt agent 80 has an interface conforming to the open POS standard specifications with respect to the POS application 70 in relation to the scanner 208, so that it is possible to appropriately change the manufacturer and the model of the scanner 208.

Similarly, the electronic receipt agent 80 includes the printer control object 804 and the printer service object 805 as software corresponding to the printer 209, and has a configuration in which the printer dummy service object 808 is further interposed between the printer control object 804 and the printer service object 805. Consequently, the electronic receipt agent 80 has an interface conforming to the open POS standard specifications with respect to the POS application 70 in relation to the printer 209, so that it is possible to appropriately change the manufacturer and the model of the printer 209.

Hereinafter, a modification example of the embodiment will be described.

In the aforementioned embodiment, the scanner 208 and the printer 209 was described as devices conforming to the USB interface; however, the scanner 208 and the printer 209 may not be devices conforming to the USB interface. However, in this case, drivers respectively corresponding to the scanner 208 and the printer 209 are required. Furthermore, in this case, the electronic receipt agent 80 does not include the USB driver 801.

In the aforementioned embodiment, data requiring an electronic receipt is used as barcode data of a member ID; however, the data requiring the electronic receipt is not always limited to the barcode data of the member ID. For example, a card number of a point card owned by a member and a member ID of the member may be stored in association with each other. The point card is assumed to be indicated by a barcode indicating the card number. In such an embodiment, when barcode data of the card number associated with the member ID is input, it is sufficient if the determination unit 8072 determines that the barcode data of the card number is the data requiring the electronic receipt.

In addition, the POS terminal 20 is generally provided in a state in which software of the POS application 70, the electronic receipt agent 80 and the like is stored in the main memory 202 or the auxiliary storage device 203. However, an embodiment is not limited thereto and the POS terminal 20 may be provided in a state in which the software is not stored in the main memory 202 or the auxiliary storage device 203. In this case, software transferred separately from the POS terminal 20 may be written in a writable storage device, which is provided to the POS terminal 20, in accordance with an operation of a user and the like. The software can be transferred by recording to a removable recording medium or communication via a network. The form of the recording medium is not problematic if the recording medium can store program like a CD-ROM, a memory card and the like and can be read by a device. Furthermore, functions obtained by installing or downloading the program may be performed in cooperation with an OS (Operation System) and the like in the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A point-of-sale (POS) device executing an electronic receipt agent to operate an electronic receipt system, wherein the electronic receipt agent comprises:
an input processing unit configured to:
receive, via an input device, data related to a commercial transaction, and
output the data related to the commercial transaction to an execution unit of an application program of the POS device that generates receipt data on the basis of the data;
a print processing unit configured to control a print device to print a receipt based on the receipt data generated by the application program of the POS device;
a transmission processing unit configured to control a communication device to transmit the receipt data to a server that stores the receipt data;
a determination unit configured to determine whether the data input via the input device requires an electronic receipt; and
a switching unit configured to:
provide the receipt data generated by the execution unit to the transmission processing unit if the determination unit determines that the data input via the input device requires the electronic receipt, and
provide the receipt data generated by the execution unit to the print processing unit if the determination unit determines that the data input via the input device does not require the electronic receipt.

2. The POS device according to claim 1, wherein
the input processing unit includes a service object that receives the data input via the input device, and a control object that provides an interface with the execution unit and outputs the input data to the execution unit, and
the determination unit includes a dummy service object that is interposed between the service object and the control object of the input processing unit, provides the data to the switching unit when the data received in the service object requires the electronic receipt, and provides the data to the control object when the data received in the service object does not require the electronic receipt.

3. The POS device according to claim 1, wherein
the print processing unit includes a control object that provides an interface with the execution unit and receives the receipt data, and a service object that controls the print device to print the receipt, and
the switching unit includes a dummy service object that is interposed between the control object and the service object of the print processing unit, provides the receipt data received by the control object to the transmission processing unit when the data received from the determination unit requires the electronic receipt, and provides the receipt data to the service object when the data received from the determination unit does not require the electronic receipt.

4. The POS device according to claim 1, wherein
the determination unit determines that the data requires the electronic receipt and provides a member ID to the switching unit when the data input via the input device is the member ID, the member ID corresponding to a member registered as a member of the electronic receipt system, and
when the member ID is provided from the determination unit, the switching unit provides the receipt data generated by the execution unit to the transmission processing unit together with the member ID.

5. The POS device according to claim 1, wherein the transmission processing unit formats the receipt data into a structured data format used in the electronic receipt system and transmits the receipt data in the structured format to the server.

6. The POS device according to claim 1, wherein the input device is a scanner and the electronic receipt agent further comprises:
a scanner interface conforming to an open POS standard specification, the electronic receipt agent being connected to the scanner through the scanner interface.

7. The POS device according to claim 1, further comprising a print interface conforming to an open POS standard specification, the electronic receipt agent being connected to the printer through the print interface.

8. A method of adapting a point-of-sale (POS) device to operate in an electronic receipt system, the method comprising:
providing an electronic receipt agent between a POS application of the POS device and a scanner and a printer, wherein the electronic receipt agent includes:
an input processing unit configured to:
receive, via an input device, data related to a commercial transaction, and
output the data related to the commercial transaction to an execution unit of an application program of the POS device that generates receipt data on the basis of the data;
a print processing unit configured to control a print device to print a receipt based on the receipt data generated by the application program of the POS device;
a transmission processing unit configured to control a communication device to transmit the receipt data to a server that stores the receipt data;
a determination unit configured to determine whether the data input via the input device requires an electronic receipt; and
a switching unit configured to:
provide the receipt data generated by the execution unit to the transmission processing unit if the determination unit determines that the data input via the input device requires the electronic receipt, and
provide the receipt data generated by the execution unit to the print processing unit if the determination unit determines that the data input via the input device does not require the electronic receipt.

9. The method according to claim 8, wherein
the input processing unit includes a service object that receives the data input via the input device, and a control object that provides an interface with the execution unit and outputs the input data to the execution unit, and
the determination unit includes a dummy service object that is interposed between the service object and the control object of the input processing unit, provides the data to the switching unit when the data received in the service object requires the electronic receipt, and provides the data to the control object when the data received in the service object does not require the electronic receipt.

10. The method according to claim 8, wherein
the print processing unit includes a control object that provides an interface with the execution unit and receives the receipt data, and a service object that controls the print device to print the receipt, and
the switching unit includes a dummy service object that is interposed between the control object and the service object of the print processing unit, provides the receipt data received by the control object to the transmission processing unit when the data received from the determination unit requires the electronic receipt, and provides the receipt data to the service object when the data received from the determination unit does not require the electronic receipt.

11. The method according to claim 8, wherein
the determination unit determines that the data requires the electronic receipt and provides a member ID to the switching unit when the data input via the input device is the member ID, the member ID corresponding to a member registered as a member of the electronic receipt system, and
when the member ID is provided from the determination unit, the switching unit provides the receipt data generated by the execution unit to the transmission processing unit together with the member ID.

12. The method according to claim 8, wherein the transmission processing unit formats the receipt data into a structured data format used in the electronic receipt system and transmits the receipt data in the structured format to the server.

13. The method according to claim 8, wherein the input device is a scanner, the agent further comprising:
a scanner interface conforming to an open POS standard specification, the agent being connected to connected to the scanner through the scanner interface.

14. The method according to claim 8, further comprising a print interface conforming to an open POS standard specification, the agent being connected to the printer through the print interface.

15. A non-transitory computer readable medium containing instructions causing a point-of-sale (POS) device to become adapted to operate in an electronic receipt system by implementing an electronic receipt agent between a POS application of the POS device and a scanner and a printer, the electronic receipt agent comprising:
an input processing unit configured to:
receive, via an input device, data related to a commercial transaction, and
output the data related to the commercial transaction to an execution unit of an application program of the POS device that generates receipt data on the basis of the data;
a print processing unit configured to control a print device to print a receipt based on the receipt data generated by the application program of the POS device;
a transmission processing unit configured to control a communication device to transmit the receipt data to a server that stores the receipt data;
a determination unit configured to determine whether the data input via the input device requires an electronic receipt; and
a switching unit configured to:
provide the receipt data generated by the execution unit to the transmission processing unit if the determination unit determines that the data input via the input device requires the electronic receipt, and
provide the receipt data generated by the execution unit to the print processing unit if the determination unit determines that the data input via the input device does not require the electronic receipt.

16. The non-transitory computer readable medium according to claim 15, wherein
the input processing unit includes a service object that receives the data input via the input device, and a control object that provides an interface with the execution unit and outputs the input data to the execution unit, and
the determination unit includes a dummy service object that is interposed between the service object and the control object of the input processing unit, provides the data to the switching unit when the data received in the service object requires the electronic receipt, and provides the data to the control object when the data received in the service object does not require the electronic receipt.

17. The non-transitory computer readable medium according to claim 15, wherein
the print processing unit includes a control object that provides an interface with the execution unit and receives the receipt data, and a service object that controls the print device to print the receipt, and
the switching unit includes a dummy service object that is interposed between the control object and the service object of the print processing unit, provides the receipt data received by the control object to the transmission processing unit when the data received from the determination unit requires the electronic receipt, and provides the receipt data to the service object when the data received from the determination unit does not require the electronic receipt.

18. The non-transitory computer readable medium according to claim 15, wherein
the determination unit determines that the data requires the electronic receipt and provides a member ID to the switching unit when the data input via the input device is the member ID, the member ID corresponding to a member registered as a member of the electronic receipt system, and
when the member ID is provided from the determination unit, the switching unit provides the receipt data generated by the execution unit to the transmission processing unit together with the member ID.

19. The non-transitory computer readable medium according to claim 15, wherein the input device is a scanner, the agent further comprising:
a scanner interface conforming to an open POS standard specification, the agent being connected to connected to the scanner through the scanner interface.

20. The non-transitory computer readable medium according to claim 15, further comprising a print interface conforming to an open POS standard specification, the agent being connected to the printer through the print interface.
